(19) United States
(12) Patent Application Publication
(10) Pub. No.: US 2024/0012917 A1
(43) Pub. Date: Jan. 11, 2024

(54) SYSTEMS AND METHODS FOR FACILITATING RESPONSES TO DETECTED ACTIVITY

(71) Applicant: MASTERCONTROL, INC., Salt Lake City, UT (US)

(72) Inventors: Chad Milito, Ogden, UT (US); Terrance L. Holbrook, Bountiful, UT (US)

(21) Appl. No.: 17/857,565

(22) Filed: Jul. 5, 2022

(51) Int. Cl. G06F 21/62; G06F 21/60; H04W 4/02

(52) U.S. Cl. CPC G06F 21/62; G06F 21/604; H04W 4/02

(57) ABSTRACT

A system obtains content access attributes associated with content presented at a user interface at a particular physical location. The content access attributes indicate intended accessibility of the content presented at the user interface at the particular physical location. The system obtains entity authorization attributes determined for an entity detected by sensors configured to obtain sensor data associated with entities positioned at the particular physical location. The entity authorization attributes are determined based upon the sensor data obtained by the sensors. Based upon the content access attributes and the entity authorization attributes, the system determines an interface security action for implementation at the user interface at the particular physical location. A system may additionally or alternatively (i) determine suspect entities based on entity authorization attributes and event attributes or (ii) determine recommended modifications to entity authorization attributes based on detected entity authorization attributes and entity activity attributes.

### BACKGROUND

Computers and computing systems have affected nearly every aspect of modern living. Computers are generally involved in work, recreation, healthcare, transportation, entertainment, household management, etc. The proliferation of computers throughout industrial and commercial spaces has led to government and industrial regulation of software and computer systems within many different business sectors.

Various government agencies exert regulatory control over companies within their jurisdictions. For example, pharmaceutical companies and manufacturers, medical device makers, and clinical research organizations are all subject to compliance regulations. These compliance regulations ensure that the companies are producing items that are safe for patients.

Similarly, many industries and companies have developed standards and procedures to ensure that processes are properly executed and that products are properly manufactured. Many of these standards and procedures utilize computer-based verifications and/or human-based verifications. For example, one or more human users may be required to ensure that a particular parameter on a manufacturing line remains within a specified range. Software may be implemented to record the users' data entries relating to the particular parameter over time. As such, an auditable record of the verification is created, and the value of the parameter can be tracked over time. In order for the auditable record to have the desired effect, there is a need for secure authentication throughout the data entry process.

As the usage of computers has continued to expand and become more vital to society, an increased need for security solutions has also become urgent. In order to maintain secure computing, it is important for users to be properly validated and for permissions to be enforced to ensure that users have only the appropriate amount of control and access to a computer system. Furthermore, there is an increased need to develop effective protocols and/or systems for detecting and/or responding to certain security events.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include computer systems, methods, and computer-readable media for facilitating responses to detected activity. In at least one embodiment, a system obtains one or more content access attributes associated with content presented at a user interface at a particular physical location. The one or more content access attributes indicate intended accessibility of the content presented at the user interface at the particular physical location. The system obtains one or more entity authorization attributes determined for an entity detected by one or more sensors configured to obtain sensor data associated with entities positioned at the particular physical location. The one or more entity authorization attributes are determined based upon the sensor data obtained by the one or more sensors. Based upon the one or more content access attributes and the one or more entity authorization attributes, the system determines an interface security action for implementation at the user interface at the particular physical location. The interface security action is configured to control access of the entity to the content presented at the user interface. The system causes implementation of the interface security action at the user interface at the particular physical location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 illustrates a schematic diagram of an embodiment of a computer system for just-in-time authentication.

FIG. 2A illustrates a conceptual representation of determining a security action based upon entity authorization attributes and content authorization attributes, and FIG. 2B illustrates a conceptual representation of causing implementation of the security action;

FIG. 3 illustrates a conceptual representation of generating recommended modifications to entity authorization attributes;

FIG. 4 illustrates a conceptual representation of determining suspect entities based upon entity authorization attributes and event attributes;

FIGS. 5 through 7 illustrate example flow diagrams depicting acts associated with the disclosed embodiments.

### DETAILED DESCRIPTION

User authentication is a fundamental component of computer security. For example, most modern operating systems utilize a permission scheme, such as POSIX, that defines what different users and processes within the operating system are allowed to access, execute, read, write, and/or otherwise interact with. A basic example of such a system may comprise an administrative user that is able to access and manipulate any file on the computer system, including system files. In contrast, a standard user may only be able to access and manipulate files that are within a particular user space that was created for that standard user.

By implementing a permission scheme, the computer system is able to verify that only particular users are able to do specific functions or access specific content. Permission schemes may be implemented by individual software applications. For example, some software applications may require that some information be entered and verified by a first employee, while other information must be entered and verified by the manager. For instance, a quality control system may require that a first employee enter data relating to the temperature of a food item being processed in a plant. A manager may then be required to enter information and/or validate that the recorded temperature is correct and within acceptable operating parameters.

A permission scheme may be implemented where access to certain functions and/or content is only intended for certain entities. For example, a permission scheme may indicate that only managers, supervisors, or high-level entities are able to view or modify certain information (e.g., standard operating procedures (SOPS) or work instructions (WIs)) while low-level employees and/or visitors/guests are not able to view or modify such information.

Notwithstanding the existence of a permission scheme, unauthorized or unintended users may still have occasion to view, modify, interact with, or otherwise access restricted content or information. For example, while an authorized individual interacts with restricted content on a computer workstation (e.g., after an appropriate authentication and/or authorization process, such as logging in), one or more unauthorized individuals may be able to view the restricted content on the computer workstation while the authorized individual interacts with it (e.g., while walking by or standing behind the authorized individual). Such instances may especially arise when shared workstations are used.

At least some disclosed embodiments are directed to systems and techniques for detecting and/or responding to potential security risks, such as unauthorized access to certain content. For example, a system may be configured to automatically detect/determine attributes of an individual within proximity to particular content (e.g., while such content is being presented at a user interface). Such attributes of the individual may include, for example, security credentials, company role, completed training, and/or others. The system may also be configured to automatically obtain attributes of the particular content, such as the security credential, company role, or completed training required to interact with or access the particular content. Based upon the attributes of the individual and the attributes of the particular content, the system may be configured to automatically select and/or cause implementation of a security action at the user interface upon which the particular content is presented. The security action may include, for instance, notifying the authorized user of the user interface that an unauthorized individual may be attempting to view or access the particular content, or automatically modifying the presentation of the content at the user interface (e.g., by hiding the content). Such systems and techniques may reduce the incidence of unauthorized access to content in a seamless, agile manner that may avoid explicit reliance on active human monitoring of unauthorized individuals.

As used herein, “content” refers broadly to any type of information, formula, pattern, compilation, program, device, machine, product, manufacture, composition, method, technique, or process. Content can thus comprise physically tangible objects/things and/or information presented via some type of user interface (e.g., a display, a speaker, etc.).

The acquisition of attributes about individuals within proximity to particular content as noted above may enable other advantageous functionalities. For example, such attributes about individuals may be used to generate recommendations about potential modifications/changes to authorization attributes for the individuals. According to at least some disclosed embodiments, a system may be configured to obtain current authorization attributes for an individual (e.g., activities/content that the individual is authorized for) and activity attributes for the individual (e.g., paths traversed by the individual, proximity to content/actions over time, etc.). The current authorization attributes and the activity attributes may be used to generate recommended changes to the individual's authorization attributes (e.g., using artificial intelligence (AI)).

By way of illustrative, non-limiting example, an individual's activity attributes may indicate that the individual spends time (through their normal course of their duties) within perceptual proximity to the performance or completion of a particular manufacturing action. The individual may thus spend time naturally positioned to witness or validate the performance or completion of the particular manufacturing action. However, the individual's current authorization attributes may indicate that the individual is not trained or authorized to witness or validate the performance or completion of the particular manufacturing action. The individual's activity attributes and current authorization attributes may be used to generate (e.g., via an AI module) a recommended modification to the individual's authorization attributes that recommends training the individual to witness and/or validate performance and/or completion of the particular manufacturing action. Such functionality may advantageously enablement improvements efficiencies within various types of enterprises.

Another example of advantageous functionality that may be implemented via the acquisition of attributes for individuals within proximity to particular content is the identification of suspect individuals in response to certain types of events. For example, a system may be configured to collect or record attributes for individuals who come into proximity to particular content. An event may subsequently occur associated with the content, and the collected attributes for the individuals that were within proximity to the content may be used to identify one or more suspect individuals (e.g., that may have contributed to the event associated with the content). Such functionality may be used to diagnose failures, identify negligent or malicious activity, and/or facilitate improvement to training, protocols, operating procedures, etc.

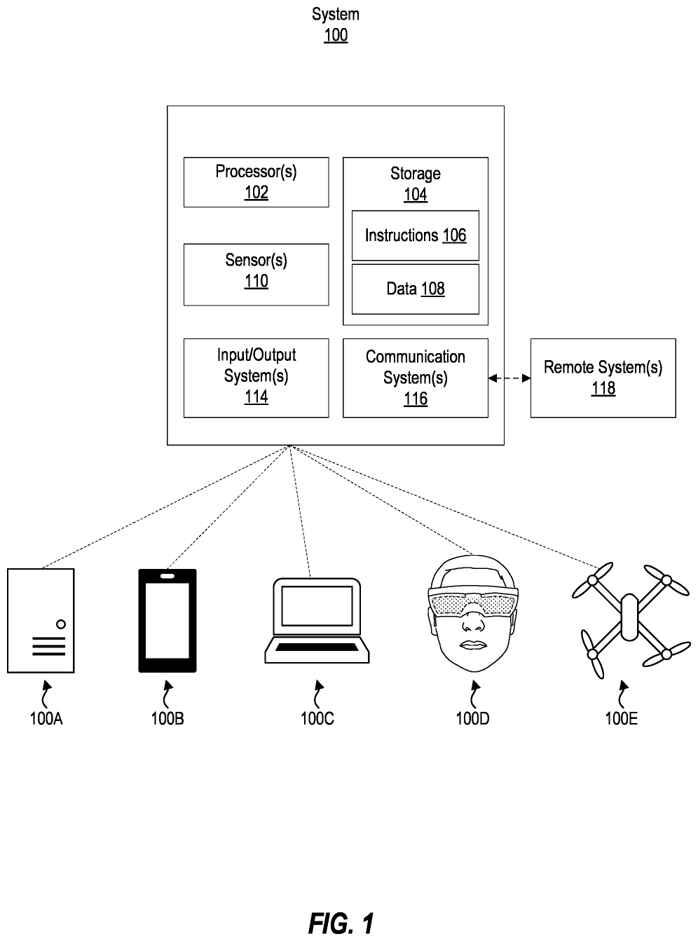

Having just described some of the various high-level features and benefits of the disclosed embodiments, attention will now be directed to FIGS. 1 through 7. These Figures illustrate various conceptual representations, architectures, methods, and supporting illustrations related to the disclosed embodiments.

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feedforward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 116 may comprise any combination of software or hardware components that are operable to facilitate communication between on-system components/devices and/or with off-system components/devices. For example, the communications system(s) 116 may comprise ports, buses, or other physical connection apparatuses for communicating with other devices/components. Additionally, or alternatively, the communications system(s) 116 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomena. By way of non-limiting example, the sensor(s) 110 may comprise one or more force sensors, image sensors (e.g., CMOS, CCD, SPAD, and/or others), scanning devices (e.g., barcode scanners, QR code scanners), motion sensors, proximity sensors, depth sensors (e.g., time-of-flight cameras, stereo cameras, rangefinders, etc.), microphones, thermal imaging sensors, heat sensors, thermometers, barometers, magnetometers, accelerometers, gyroscopes, inertial measurement units (IMUs), biometric sensors, and/or others. It will be appreciated that communication system(s) 116 may operate as sensor(s) 110 in some instances (e.g., in the form of near-field communication (NFC) systems, radio-frequency identification (RFID) systems, etc.).

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize various types of devices, such as server 100A, mobile electronic device 100B (e.g., a smartphone), personal computing device 100C (e.g., a laptop), a mixed-reality head-mounted display 100D (HMD 100D), aerial vehicle 100E (e.g., a drone), and/or other devices.

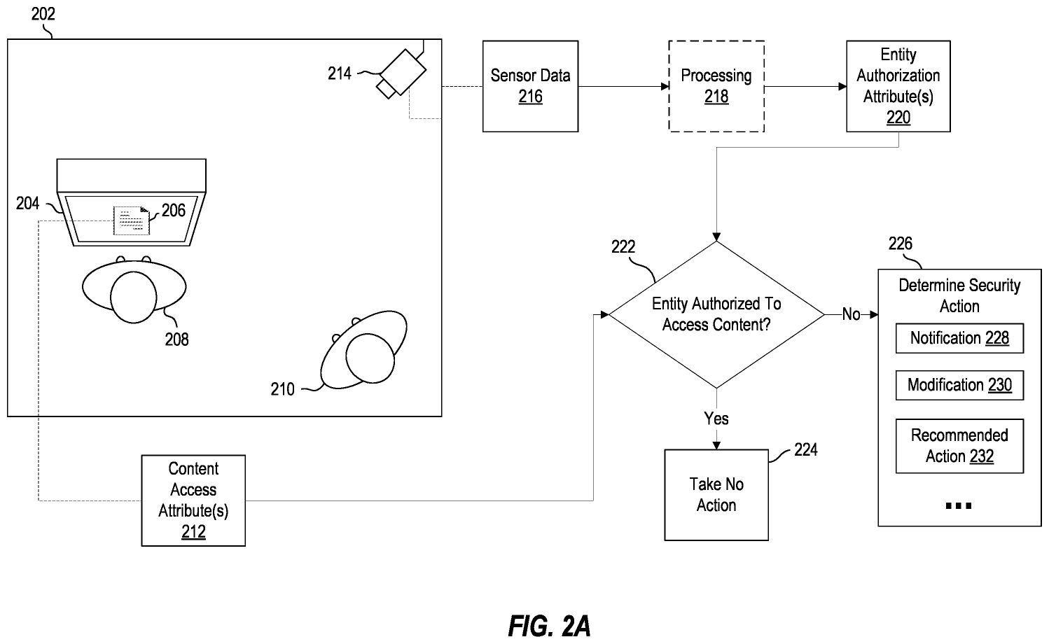

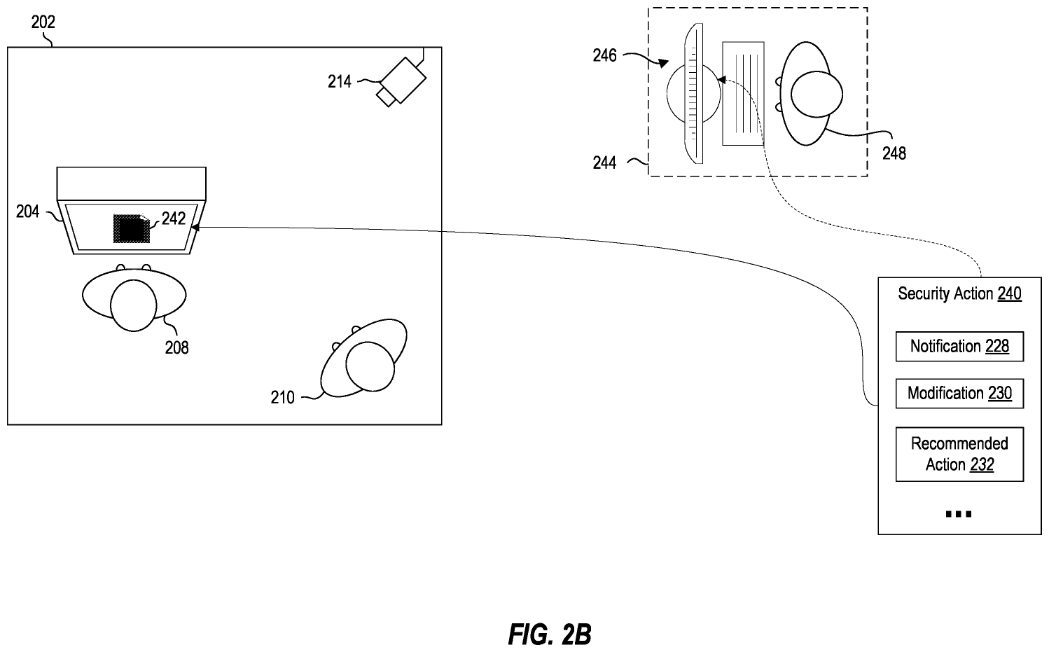

FIG. 2A illustrates a conceptual representation of determining a security action based upon entity authorization attributes and content authorization attributes. In particular, FIG. 2A shows a physical location 202, which may comprise any physical space within which content may be positioned, displayed, acted upon, etc. The physical location 202 may comprise any type of physical environment such as, by way of non-limiting example, an office location, a manufacturing location, a government location, an educational or research location, a residential location, a military or defense location, and/or others.

FIG. 2A shows an example of a user interface 204 displaying content 206 within the physical location 202. The user interface 204 may include a display of a computer system that comprises one or more components discussed hereinabove with reference to the system 100 of FIG. 1. The content 206 displayed on the user interface 204 in the example of FIG. 2A comprises textual content, but other types of content are within the scope of the present disclosure (e.g., audio content). Although the example discussed herein with reference to FIGS. 2A and 2B focuses, in at least some respects, on content presented on an electronic user interface, other types of content may be implemented in accordance with the present disclosure (e.g., content may comprise physical objects, holograms, live specimens, audio content, and/or others as noted hereinabove). Furthermore, in some instances, the content is provided in association with the user interface (e.g., where the content comprises physical content situated adjacent to or within the same room/space as the user interface, even where the content is not necessarily displayed on the user interface).

In the example of FIG. 2A, entity 208 interacts with the content 206 presented at the user interface 204. Entity 208 may have authorization to interact with the content 206. Such authorization may be defined according to content access attribute(s) 212 associated with the content 206 (the association being depicted in FIG. 2A via the dashed line connecting the content access attribute(s) 212 to the content 206). At a basic level the content access attribute(s) 212 may indicate or specify entities and/or groups of entities that are authorized to interact with the content 206 (e.g., similar to the permission schema discussed hereinabove). For example, the content access attribute(s) 212 may include a list of authorized entities (e.g., individuals, groups of individuals) and/or any information associated with the authorized entities (e.g., biometric information, user profile or user login information, physical token information such as RFID or NFC information, etc.). The content access attribute(S) 212 may indicate an authorization level for accessing the content (e.g., required company role, level of training, security clearance, etc.) and/or may indicate authorized credentials or tokens for accessing the content 206 (e.g., passwords, physical tokens such as RFID or NFC tokens, etc.). The content access attribute(s) 212 may additionally or alternatively indicate the types of interactions that are permitted for certain entities.

Content access attribute(s) 212 may additionally or alternatively include or be based upon a content type associated with the content 206. For example, a particular type of content (e.g., SOPs, WIs) may only be modifiable by some entities (e.g., supervisors or higher), while other entities (e.g., low-employees) may only be able to view the particular type of content. As another example, content indicated as a “procedure” content type may be treated differently (e.g., giving different entities different levels of permissions) than content indicated as a “recipe” content type (e.g., even where both contents have the same file type). Content access attribute(s) 212 may additionally or alternatively include or be based upon one or more content tags associated with the particular item of content (e.g., tags such as whether the content includes a trade secret or other confidential information, is export sensitive, is associated with an ethical wall, etc.).

In some instances, the content access attribute(s) 212 determine user and/or physical attributes for accessing the content 206. For example, the content access attribute(s) 212 may define a proximity to the user interface 204 required for entities to be able to access the content 206 at the user interface 204 (e.g., within 1 meter). Other user and/or physical attributes for accessing the content 206 may include required entity attire (e.g., only entities properly gowned or equipped with instruments can access the content, or entities equipped with unauthorized instruments cannot access the content), bodily conditions (e.g., temperature, weight, emotional state), and/or others. For example, content access attribute(s) 212 may indicate that entities with recording devices (e.g., a smartphone) are unauthorized to access the content 206.

In the example of FIG. 2A, the content access attribute(s) 212 indicate that entity 208 is authorized to interact with the content 206. FIG. 2A also shows another entity 210 in the physical location 202, which is not authorized to interact with the content 206 according to the content access attribute(s) 212. The presence of entity 210 within the physical location 202 where entity 208 is interacting with the content 206 may pose a risk that entity 210 views, perceives, interacts with, modifies, or otherwise accesses the content 206 (which entity 210 is unauthorized to access).

Accordingly, at least some disclosed techniques may enable agile detection of authentication and/or authorization attributes of individuals within the physical location 202 to mitigate risks associated with unauthorized access to the content 206.

FIG. 2A conceptually depicts sensor(s) 214 arranged to obtain sensor data 216 associated with entities within the physical location 202. The sensor(s) 214 may correspond to the sensor(s) 110 discussed hereinabove with reference to FIG. 1. The sensor data 216 obtained by the sensor(s) 214 may indicate (e.g., via processing 218) entity authorization attribute(s) 220 for entities 208 and 210 present within the physical location 202.

The entity authorization attribute(s) 220 may include various information and/or metrics about the entities present within the physical location 202 for determining whether the entities are authorized to interact with the content 206. For example, the entity authorization attribute(s) may include or be based upon entity type (e.g., to distinguish between human and non-human entities). Entity authorization attribute(s) 220 may include or be based upon entity identity, such as whether the detected entity/entities can be authenticated to correspond to known identities. Entity identity may be determined utilizing various types of sensor data 216, such as biometric sensor data (e.g., voice authentication, facial authentication, fingerprint/handprint authentication, iris authentication, and/or others), token recognition sensor data (e.g., NFC, RFID, barcode, QR code, and/or others), etc.

The entity authorization attribute(s) 220 may additionally or alternatively include or be based upon one or more entity tags (which may in some instances be determined based upon the entity identity, as discussed above). Entity tags may include or indicate, by way of non-limiting example, entity role (e.g., role within an enterprise, such as supervisor, manager, low-level employee; status as employee or independent contractor; status as visitor/guest; etc.) or lack of role (e.g., indicating that the entity is not part of an enterprise), login or authentication status (e.g., whether the entity has properly logged in, such as by using multi-factor authentication, whether the entity has properly checked in for entry into the physical location 202, etc.), entity status (e.g., entity's authorization level, whether entity is on probation, entity holds valid licenses, entity trainings/credentials complete, compliance with time-bound or location-bound authorization that has been granted, etc.), and/or others.

The entity authorization attribute(s) 220 may additionally or alternatively include or be based upon recorded activity for the entity (e.g., login recency, number of logins, prior page views or content accessed, past breaches or violations, action performance history, action witnessing history, action validation history, etc.).

The entity authorization attribute(s) 220 may additionally or alternatively include or be based on entity state. In some instances, entity state includes a physical state of the entity, such as the entity's specific location and/or location/proximity relative to content (e.g., content 206). The entity state may include pose information for the entity (e.g., via body joint feature extraction from image data capturing the entity), activity state for the entity (e.g., inferred based on extracted body joint features over multiple frames), estimated emotional or mental or bodily state for the entity (e.g., based upon facial landmark extraction, pose/activity extraction, temperature information, etc.), entity attire, instruments held/used by entity (e.g., via object recognition), and/or others.

In some instances, as shown in FIG. 2A, the sensor data 216 is processed (via processing 218) to determine the entity authorization attribute(s) 220. For example, at least some of the sensor data 216 may be used as input to one or more artificial intelligence (AI) modules that are configured to determine entity authorization attributes based on input sensor data. Such AI modules may be configured, for example, to infer or label recognized objects, recognized facial or body cues (e.g., to determine bodily pose, emotional state, physical activity/action, etc.) based upon input image and/or other data. The processing 218 may implement additional or alternative techniques/components, such as mathematical models (e.g., to facilitate facial, iris, voice, and/or other biometric authentication), rules-based or logic-based architectures, databases (e.g., human resource information system databases to determine entity roles, authorization levels, etc.), and/or others.

The entity authorization attribute(s) 220 and the content access attribute(s) 212 may provide a basis for determining whether and/or how to (continue to) present the content 206 at the user interface 204. As noted above, in the example of FIG. 2A, the content access attribute(s) 212 may indicate that entity 208 is authorized to interact with the content 206, thereby enabling the content 206 to be presented at the user interface 204 (for example, entity 208 may log in using credentials recognized in accordance with the content access attribute(s) 212); or sensor data 216 depicting entity 208 may be captured, entity authorization attribute(s) 220 may be determined using the sensor data 216, and the entity authorization attribute(s) 220 may indicate that entity 208 is authorized to interact with the content 206 in accordance with the content access attribute(s) 212, thereby enabling presentation of the content 206 at the user interface 204.

In the example of FIG. 2A, entity 210 has entered the physical location 202, and the content access attribute(s) 212 indicate that entity 210 is not authorized to access the content 206. To prevent or mitigate the potential for unauthorized entities to perceive or otherwise access the content 206, a system may obtain entity authorization attribute(s) 220 associated with the entities within the physical location 202, including entity 210. As noted above, the entity authorization attribute(s) 220 may be based upon sensor data 216 acquired by the sensor(s) 214. The entity authorization attribute(s) 220 may indicate, for example, an authorization level for entity 210.

Continuing with the example of FIG. 2A, the system may obtain the content access attribute(s) 212 associated with the content 206 presented at the physical location 202 and determine a requisite authorization level for accessing the content 206. The system may assess the detected authorization level for entity 210 (and/or other aspects of the entity authorization attribute(s) 220) relative to the requisite authorization level for accessing the content 206 (and/or other aspects of the content access attribute(s) 212) to determine whether entity 210 is authorized to access the content 206 (as indicated in FIG. 2A by decision block 222 with arrows extending from the entity authorization attribute(s) 220 and the content access attribute(s) 212 toward decision block 222).

If entity 210 were to be determined to be authorized to access the content 206 based upon the entity authorization attribute(s) 220 and the content access attribute(s) 212, a system may, in some instances, take no action (as indicated in FIG. 2A by action 224 following from the “Yes” designation associated with decision block 222), thereby allowing for continued presentation of the content 206 at the user interface 204. If, on the other hand, entity 210 is determined to not be authorized to access the content 206, a system may determine a security action (as indicated in FIG. 2A by action 226 following from the “No” designation associated with decision block 222). The security action may comprise an interface security action for implementation at the user interface 204 that is configured to control access to the content 206. The security action may be selected based upon whether the analyzed entity/entities is/are authorized to access the content 206.

FIG. 2A depicts examples of security actions that may be selected in accordance with action 226, including notification 228, modification 230, recommended action 232, and/or others (depicted in FIG. 2A by the ellipsis). A notification 228 may include a presentation configured to indicate one or more aspects of a security risk to users (e.g., entity 208 and/or other entities at the physical location 202). The notification may enable the users to take action to mitigate the security risk (e.g., the risk of entity 210 perceiving or otherwise accessing the content 206). Aspects of the security risk that could be communicated via a notification 228 include, but are not limited to, information about the entity associated with the risk (e.g., entity 210), potential harm that could ensue from the risk going unmitigated, a threat level associated with the risk, etc.

It will be appreciated, in view of the present disclosure, that a notification may be provided in some instances even where a detected entity is authorized to interact with presented content (e.g., to prevent users interacting with the content from becoming unduly concerned that an unauthorized entity might perceive or access the content).

A modification 230 may comprise a change to the presentation of the content 206 at the user interface 204 (e.g., to prevent entity 210 from accessing the content 206). Examples of modification 230 may comprise halting activity at the user interface or closing, blurring, hiding, or otherwise obscuring or de-emphasizing the content 206 initially presented on the user interface 204. In accordance with the present disclosure, a modification 230 may be implemented outside of the context of a user interface, such as by activation of one or more devices for preventing unauthorized perception and/or access to content (e.g., devices that obstruct field of view, such as shades, smartglass, etc.).

Recommended action 232 may comprise providing an indication of recommended response to the security risk (e.g., the presence of entity 210 relative to the content 206). Example recommended action 232 may include prompting a user to turn off the workstation (e.g., user interface 204), implement one or more devices for protecting or maintaining secrecy of the content 206, escort the unauthorized entity/entities out of the physical location 202, escalate the issue with security or other personnel, etc.

One will appreciate, in view of the present disclosure, that notification 228, modification 230, and/or recommended action 232 may be selected individually or in combination in accordance with action 226. A system may cause implementation of the selected security action(s) at the user interface 204 (and/or at other systems or locations). FIG. 2B conceptually depicts the security action 240 (one or more of notification 228, modification 230, recommended action 232, and/or other actions selected in accordance with action 226 of FIG. 2A) being implemented at the user interface 204, as indicated in FIG. 2B by the modified representation of the content 242 and by the solid arrow extending from the security action 240 toward the user interface 204. In some implementations, the notification 228, the modification 230, and/or the recommended action 232 is implemented at the user interface 204 automatically (e.g., without relying on input by users interacting with the user interface 204).

FIG. 2B shows that, in some implementations, a security action 240 may be implemented at one or more additional or alternative locations or systems, such as at a user interface 246 at a separate location 244 that is separate from the physical location 202 (e.g., at a security office, at first responder system, etc.), thereby enabling one or more other entities 248 to respond to the security threat (e.g., the presence of unauthorized entity 210 relative to the content 206). The security action implemented at the separate location 244 may be the same as or different from the security action implemented at the physical location 202.

Implementing a security action at the user interface 204 as discussed herein may address potential unauthorized exposure of the content 206 to unauthorized entities (e.g., entity 210). One will appreciate, in view of the present disclosure, that systems may cease to implement security action(s) vis-à-vis the content 206 in response to detecting that the security risk is no longer present (e.g., in response to the sensor data 216 indicating that entity 210 is no longer present or is otherwise no longer a security risk relative to the content 206). Accordingly, for example, presentation of and/or access to the content 206 at the user interface 204 may be selectively enabled for authorized entities, and presentation of and/or access to the content may be selectively disabled for unauthorized entities (such disabling may occur when both authorized and unauthorized entities are present).

Although the foregoing examples have focused, in at least some respects, on the use of entity authorization level (indicated by the entity authorization attribute(s) 220) and requisite authorization level for accessing content (indicated by the content access attribute(s) 212) as a basis for determining whether an entity is authorized to access content, other aspects and/or combinations of the content access attribute(s) 212 and/or the entity authorization attribute(s) 220 (such as any of those described hereinabove) may be utilized for determining whether and/or which security action(s) is/are appropriate.

As another example, entity proximity to the content 206 may be considered when determining whether to select and/or implement a security action. For instance, when an authorized entity enters and/or remains within an allowed proximity for accessing the content 206 (the allowed proximity being indicated by the content access attribute(s) 212, and the authorized entity's proximity being indicated by the entity authorization attribute(s) 220) presentation of the content 206 may be permitted, whereas, when an unauthorized entity enters and/or remains within the allowed proximity for accessing the content 206, a security action may be implemented relative to the content 206.

Related to the above example associated with entity proximity, the content access attribute(s) 212 may include information related to the perceivability of the content, such as the viewing perspectives within the physical location 202 from which an entity might be able to access or perceive the content (e.g., accounting for hardware configuration, room characteristics/arrangement, etc.), and the entity authorization attribute(s) 220 may include information to the field of perception of entities (e.g., ranges associated with senses of the entities). Such factors may be considered when determining whether to select and/or implement a security action.

One will appreciate, in view of the present disclosure, that the particular sensors used, the particular aspects of the content access attribute(s) 212, the particular aspects of the entity authorization attribute(s) 220, and/or the particular security actions may vary based on intended use, enterprise needs or concerns, the type of content, and/or other factors.

Although the physical location 202 of FIGS. 2A and 2B is a single room, a physical location 202 may comprise any physical environment or collection of physical environments (e.g., multiple rooms, an entire building, a set of buildings). Accordingly, sensor(s) may be additionally or alternatively arranged to detect entities outside of the particular room within which the content 206 is accessible. In this sense, security actions may be implemented at user interfaces in anticipation of entities approaching the location at which the content is accessible (e.g., where an unauthorized entity is detected as moving toward a location where the protected content is accessible, even where the detected entity has not yet reached the location).

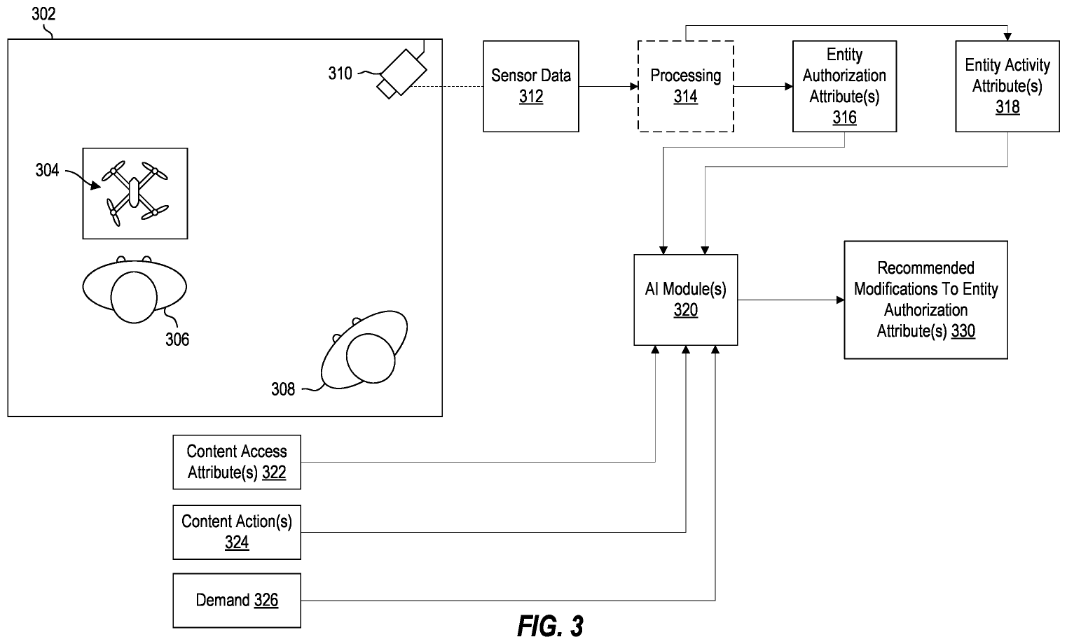

FIG. 3 illustrates a conceptual representation of generating recommended modifications to entity authorization attributes. In particular, FIG. 3 shows a physical location 302 (similar to physical location 202) within which content 304 (e.g., a drone) is being manufactured. In the example of FIG. 3, entity 306 performs an action pursuant to the manufacturing of the content 304. Many manufacturing protocols require another entity to witness and/or validate actions performed to manufacture articles.

FIG. 3 shows another entity 308 within the physical location 302. Entity 308 is not authorized to witness and/or validate the action performed by entity 306 to manufacture the content 304. For example, entity 308 may be present in the physical location 302 pursuant to other duties. Additional efficiency might be realized by training entity 308 to witness and/or validate the actions performed by entity 306 to manufacture the content 304. However, the potential to realize such efficiency gains may go undetected in many instances.

Accordingly, at least some disclosed techniques are directed to generating recommendations for modifying entity authorization attributes for detected entities. By way of example, FIG. 3 illustrates sensor(s) 310 (similar to sensor(s) 214 and/or sensor(s) 110) arranged to obtain sensor data 312 for entities within the physical location 302, including entity 308. The sensor data 312 may be processed (e.g., via processing 314) to determine entity authorization attribute(s) 316 and entity activity attribute(s) 318 for the entity 308. The entity authorization attribute(s) 316 correspond generally to the entity authorization attribute(s) 220 discussed hereinabove. The entity authorization attribute(s) 316 may indicate an authorization level for the detected entity (e.g., entity 308) relative to the performance of actions associated with the content (e.g., witnessing and/or validating actions for the manufacturing of content 304).

The entity activity attribute(s) 318 may indicate activities and/or states embodied by the detected entities (e.g., entity 308). For example, entity activity attribute(s) 318 may indicate the states embodied by the detected entity (e.g., whether idle or active) and/or the activity/activities engaged in by the detected entity within the physical location 302 (e.g., based on pose analysis over time, attire and/or instruments used), idle time for the entity within the physical location 302, gaze directions and/or durations for the entity, etc.

The entity authorization attribute(s) 316 and the entity activity attribute(s) 318 may provide a basis for generating recommended modifications to the entity authorization attributes for detected entities (e.g., whether to recommend training or authorizing entity 308 to perform witness and/or validation functions for the manufacturing of the content 304). A system may obtain the entity authorization attribute(s) 316 and the entity activity attribute(s) 318 as noted above. In some instances, the system may obtain additional information in relation to the content 304 and/or an enterprise associated with the content 304, such as content access attribute(s) 322, content action(s) 324, and/or demand 326 as shown in FIG. 3. The content access attribute(s) 322 correspond generally to the content access attribute(s) 212 discussed hereinabove. The content action(s) 324 may indicate actions that entities may become authorized to perform relative to content (e.g., for content 304, the content action(s) 324 may indicate various manufacturing actions and corresponding witnessing actions and/or validation actions). The demand 326 may indicate a need for additional authorized entities for performing one or more of the content action(s) 324 (e.g., the demand 326 may indicate a shortage of witnesses for manufacturing actions, or that inefficiencies are arising with respect to witnesses).

A system may provide at least some aspects of the entity authorization attribute(s) 316, the entity activity attribute(s) 318, the content access attribute(s) 322, the content action(s) 324, and/or the demand 326 as input to one or more AI module(s) 320, which may be trained or configured to generate the recommended modifications to entity authorization attributes 330. By way of illustrative example, the content action(s) 324 may indicate that witnessing actions are available for the manufacturing actions performed by entity 306 on the content 304, the demand 326 may indicate that additional efficiencies may be realized by authorizing additional entities to perform the witnessing actions, the entity authorization attribute(s) 316 (and/or the content access attribute(s) 322) may indicate that entity 308 is not presently authorized to perform the witnessing actions, and the entity activity attribute(s) 318 may indicate that entity 308 spends sufficient idle time within location 302 to perform the witnessing actions. Such inputs may be utilized by the AI module(s) 320 to generate the recommended modifications to entity authorization attribute(s) 330, which may comprise a recommendation to train entity 308 to witness manufacturing actions performed by entity 306 on the content 304.

One will appreciate, in view of the present disclosure, that, in some instances, fewer than all of the inputs noted above for the AI module(s) 320 may be utilized to generate the recommended modifications to entity authorization attribute(s) 330. For example, the AI module(s) 320 may utilize only the entity authorization attribute(s) 316 and the entity activity attribute(s) 318 as inputs. Furthermore, although the foregoing example focuses, in at least some respects, on a manufacturing example (e.g., including manufacturing, witnessing, and validation actions), the principles noted above may be applied in other contexts as well.

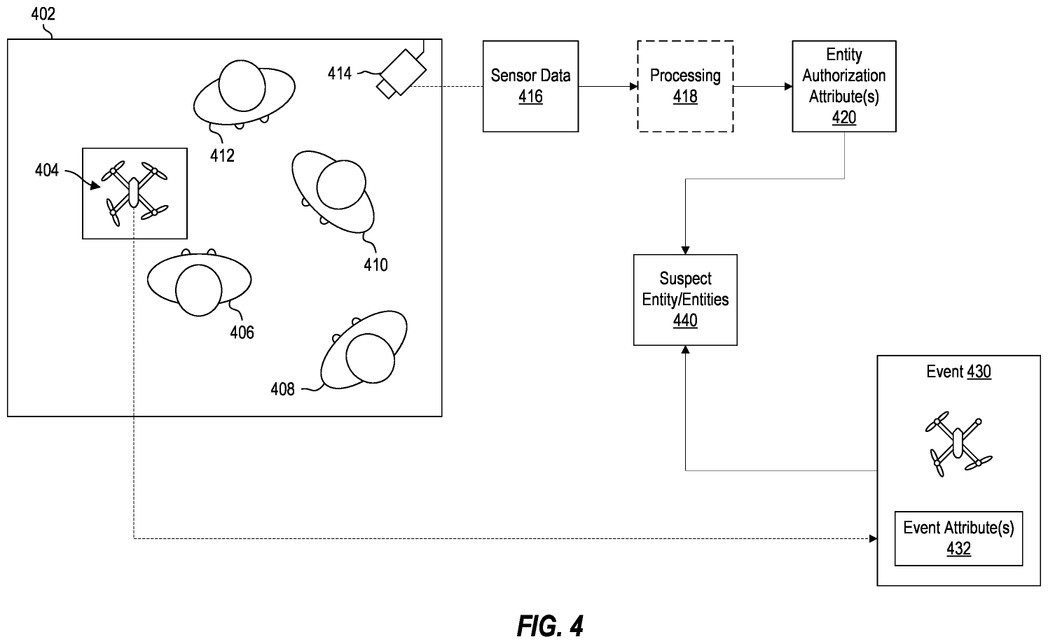

As noted above, the acquisition of entity authorization attributes may be utilized to determine suspect entities in response to detection of particular events (e.g., in response to product failures, information misappropriation, etc.). FIG. 4 illustrates a conceptual representation of determining suspect entities based upon entity authorization attributes and event attributes. In particular, FIG. 4 shows a physical location 402 similar to physical locations 302 and 202. The physical location 402 includes content 404 (e.g., a drone) subject to a manufacturing process. In the example of FIG. 4, multiple entities 406, 408, 410, and 412 are positioned within the physical location 402 along with the content 404. Although four entities are illustrated in the physical location 402, any number of entities could be detected across any number of timepoints in accordance with the present disclosure.

A system may obtain entity authorization attribute(s) 420 for the entities 406, 408, 410, and 412 while the entities 406, 408, 410, and 412 are present within the physical location 402 with the content 404. The entity authorization attribute(s) 420 generally corresponds to the entity authorization attribute(s) 316 and/or 220 discussed hereinabove. The entity authorization attribute(s) 420 may be obtained (e.g., via processing 418) based upon sensor data 416 (corresponding generally to sensor data 216 and/or 312 discussed hereinabove) acquired via sensor(s) 414 (corresponding generally to sensor(s) 214, 310, and/or 110 discussed hereinabove).

In the example of FIG. 4, subsequent to the acquisition of the entity authorization attribute(s) 420, an event 430 associated with the content 404 occurs, indicated by the dashed line extending from the content 404 to the event 430 in FIG. 4. In FIG. 4, the event 430 depicts the content 404 (e.g., the drone) with a missing or failed component (e.g., the front-right propellor), which may comprise a failure of the content. The failure may result from tampering or improper actions toward the content 404 at previous timepoints (e.g., during manufacture). As will be discussed below, the entity authorization attribute(s) 420 may provide a basis for determining additional information related to the event 430 that occurred associated with the content 404 (e.g., additional information such as suspect entities that came into contact with the content 404).

The event 430 may include or be associated with event attribute(s) 432 indicating various aspects of the event 430, such as timing for the event, information identifying the content 404 associated with the event 430, a type for the event, etc. The type for the event may comprise, by way of non-limiting example, content failure, content corruption, content modification, content misuse (e.g., misappropriation, copying, moving, disclosure, etc.), and/or others.

A system may identify suspect entity/entities 440 based upon the entity authorization attribute(s) 420 and the event attribute(s) 432. For example, where the event attribute(s) 432 identify the content 404 associated with the event, the entity authorization attribute(s) 420 may indicate the entities (e.g., entities 406, 408, 410, and 412) that were previously within physical proximity to the content 404. Such entities (e.g., entities 406, 408, 410, and 412 in the example of FIG. 4) may thus be identified as suspect entities 440.

In some instances, suspect entities 440 are selected based on their status as being unauthorized to interact with the content 404 and having been within physical proximity to the content. For example, a system may assess the entity authorization attribute(s) 420 relative to the event attribute(s) 432 (which may include content access attributes for the content associated with the event) to determine whether and/or which of the entities to which the content 404 was exposed were authorized to access or interact with the content 404. Entities that were unauthorized to access the content 404 and that came within physical proximity to the content 404 may be identified as suspect entities 440. One will appreciate that other aspects of the entity authorization attribute(s) 420 may be utilized to identify suspect entity/entities 440 (e.g., body temperature or other indications of illness, which may have given rise to corruption of content; entities not wearing proper attire or using proper instruments or using instruments properly; etc.).

One will appreciate, in view of the present disclosure, that additional or alternative information may be used to determine the suspect entity/entities 440. For example, the entity authorization attribute(s) 420 may be timestamped to indicate the timepoints and/or time periods when the content 404 was exposed to the entities 406, 408, 410, and 412. Actions performed on the content 404 (e.g., manufacturing actions) may similarly be timestamped to correlate the presence of the entities 406, 408, 410, and 412 (e.g., based on the entity authorization attribute(s) 420) with the actions performed. The event attribute(s) 432 may indicate or may be used to determine one or more previous actions performed on the content 404 that may have given rise to the event 430. For instance, types of previously performed manufacturing actions may be identified that are associated with the component(s) of the content 404 that failed in accordance with the event 430 (e.g., in the example of FIG. 4, actions associated with assembling the front right propellor may be selected). Suspect entities 440 may thus be identified based on their proximity or exposure to the content 404 being correlated with actions determined to have possibly given rise to the event 430.

In some instances, the entity authorization attribute(s) 420 may indicate particular actions performed by the entities 406, 408, 410, and 412 on the content 404 (e.g., via pose extraction over multiple frames), and suspect entities 440 may be identified based on their performance of particular actions on the content 404.

One will appreciate, in view of the present disclosure, that the event 430 may occur during acquisition of sensor data 416 for determining the entity authorization attribute(s) 420, or the occurrence of the event 430 may trigger acquisition of the sensor data 416 for determining the entity authorization attribute(s). Although the examples discussed with reference to FIG. 4 focus, in at least some respects, on a manufacturing context, the principles discussed may be applied to other domains.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

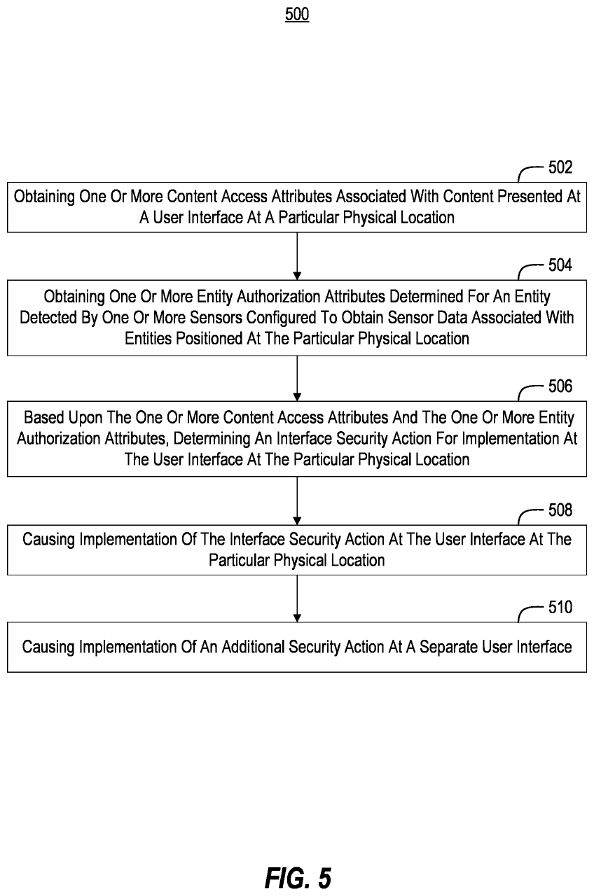

FIGS. 5 through 7 illustrate example flow diagrams depicting acts associated with the disclosed embodiments.

Act 502 of flow diagram 500 of FIG. 5 includes obtaining one or more content access attributes associated with content presented at a user interface at a particular physical location. The one or more content access attributes may indicate intended accessibility of the content presented at the user interface at the particular physical location. The one or more content access attributes may comprise or be based upon one or more of: content type, content tag, authorization level for accessing the content, one or more user attributes for accessing the content, authorization level for accessing the physical location, or content perceivability.

Act 504 of flow diagram 500 includes obtaining one or more entity authorization attributes determined for an entity detected by one or more sensors configured to obtain sensor data associated with entities positioned at the particular physical location. The one or more entity authorization attributes may be determined based upon the sensor data obtained by the one or more sensors. In some instances, the one or more sensors comprise one or more: force sensors, image sensors, scanning devices, wireless communication systems, motion sensors, proximity sensors, depth sensors, thermal imaging sensors, heat sensors, microphones, or biometric sensors. In some implementations, the one or more entity authorization attributes comprise one or more of: entity type, entity identity, entity tags, entity state, recorded activity, or field of perception. In some implementations, the one or more entity authorization attributes are determined by providing the sensor data as input to one or more artificial intelligence (AI) modules. The one or more AI modules may be configured to determine entity authorization attributes based on input sensor data.

Act 506 of flow diagram 500 includes, based upon the one or more content access attributes and the one or more entity authorization attributes, determining an interface security action for implementation at the user interface at the particular physical location. The interface security action may be configured to control access of the entity to the content presented at the user interface. In some implementations, act 506 includes assessing the one or more entity authorization attributes relative to the one or more content access attributes to determine whether the entity is authorized to access the content presented at the user interface at the particular physical location. The interface security action may be selected based upon whether the entity is authorized to access the content presented at the user interface at the particular physical location. In some implementations, the interface security action comprises a notification presented at the user interface at the particular location. In some instances, the interface security action comprises a modification to the presentation of the content at the user interface at the particular physical location. In some instances, the interface security action comprises presentation of a recommended action at the user interface at the particular location.

Act 508 of flow diagram 500 includes causing implementation of the interface security action at the user interface at the particular physical location.

Act 510 of flow diagram 500 includes causing implementation of an additional security action at a separate user interface.

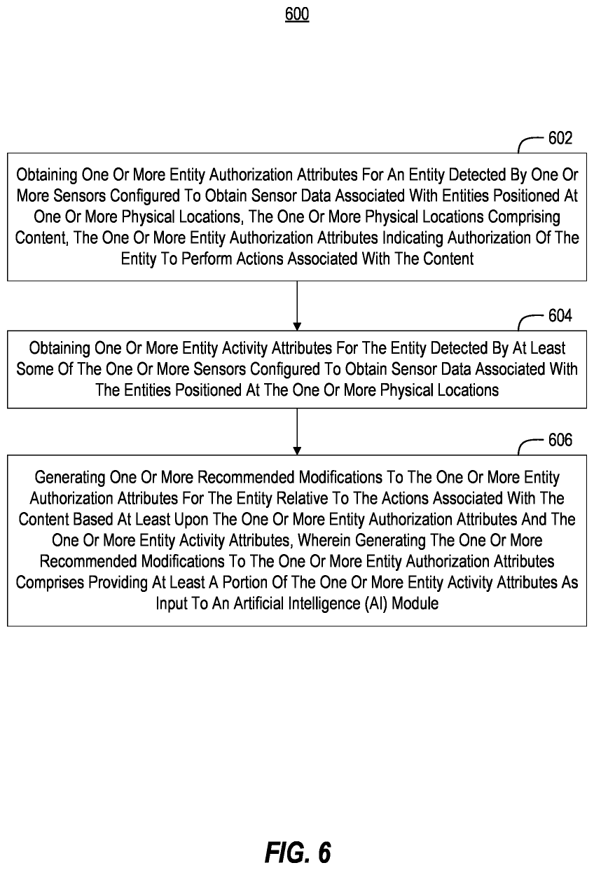

Act 602 of flow diagram 600 of FIG. 6 includes obtaining one or more entity authorization attributes for an entity detected by one or more sensors configured to obtain sensor data associated with entities positioned at one or more physical locations, the one or more physical locations comprising content, the one or more entity authorization attributes indicating authorization of the entity to perform actions associated with the content. In some implementations, the one or more sensors comprise one or more: force sensors, image sensors, scanning devices, wireless communication systems, motion sensors, proximity sensors, depth sensors, thermal imaging sensors, heat sensors, microphones, or biometric sensors. The one or more entity authorization attributes may comprise one or more of: entity type, entity identity, entity tags, entity state, recorded activity, or field of perception.

Act 604 of flow diagram 600 includes obtaining one or more entity activity attributes for the entity detected by at least some of the one or more sensors configured to obtain sensor data associated with the entities positioned at the one or more physical locations. In some instances, the one or more entity activity attributes are indicative of activities and/or states embodied by the entity while within the one or more physical locations.

Act 606 of flow diagram 600 includes generating one or more recommended modifications to the one or more entity authorization attributes for the entity relative to the actions associated with the content based at least upon the one or more entity authorization attributes and the one or more entity activity attributes, wherein generating the one or more recommended modifications to the one or more entity authorization attributes comprises providing at least a portion of the one or more entity activity attributes as input to an artificial intelligence (AI) module. The AI module is configured to generate recommended modifications to authorization attributes for entities based at least upon input entity activity attributes. The one or more recommended modifications to the one or more entity authorization attributes may be generated further based upon a demand associated with actions associated with the content.

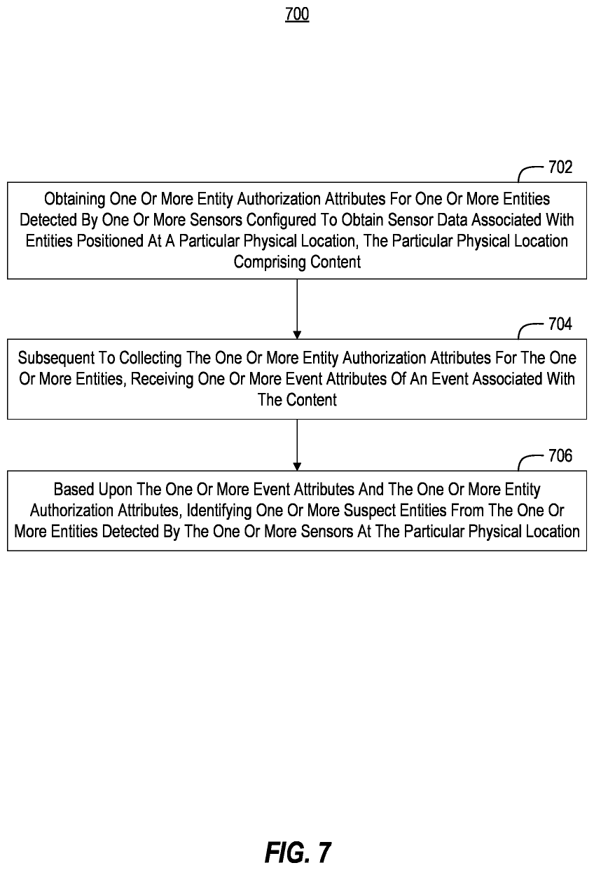

Act 702 of flow diagram 700 of FIG. 7 includes obtaining one or more entity authorization attributes for one or more entities detected by one or more sensors configured to obtain sensor data associated with entities positioned at a particular physical location, the particular physical location comprising content. In some implementations, the one or more sensors comprise one or more: force sensors, image sensors, scanning devices, wireless communication systems, motion sensors, proximity sensors, depth sensors, thermal imaging sensors, heat sensors, microphones, or biometric sensors. The one or more entity authorization attributes may comprise one or more of: entity type, entity identity, entity tags, entity state, recorded activity, or field of perception. The one or more entity authorization attributes may be determined by providing the sensor data as input to one or more artificial intelligence (AI) modules, the one or more AI modules being configured to determine entity authorization attributes based on input sensor data.

Act 704 of flow diagram 700 includes, subsequent to collecting the one or more entity authorization attributes for the one or more entities, receiving one or more event attributes of an event associated with the content. In some implementations, the one or more event attributes comprise one or more indications of: content failure, content corruption, content modification, or content misuse.

Act 706 of flow diagram 700 includes, based upon the one or more event attributes and the one or more entity authorization attributes, identifying one or more suspect entities from the one or more entities detected by the one or more sensors at the particular physical location. In some instances, act 706 includes assessing the one or more entity authorization attributes relative to the one or more event attributes to determine whether the one or more entities were authorized to access the content of the particular physical location. In some instances, at least some of the one or more suspect entities are identified based upon whether the one or more entities were authorized to access the content of the particular physical location.

The methods may be practiced by a computer system including one or more processors and computer-readable media such as computer memory (e.g., physical hardware storage devices). In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud- and remote-based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for facilitating a response to a detected activity, comprising:
one or more processors; and
one or more hardware storage devices storing instructions that are executable by the one or more processors to configure the system to:
obtain one or more content access attributes associated with content presented at a user interface at a particular physical location, the one or more content access attributes indicating intended accessibility of the content presented at the user interface at the particular physical location;
obtain one or more entity authorization attributes determined for an entity detected by one or more sensors configured to obtain sensor data associated with entities positioned at the particular physical location, the one or more entity authorization attributes being determined based upon the sensor data obtained by the one or more sensors;
based upon the one or more content access attributes and the one or more entity authorization attributes, determine an interface security action for implementation at the user interface at the particular physical location, wherein the interface security action is configured to control access of the entity to the content presented at the user interface; and
cause implementation of the interface security action at the user interface at the particular physical location.

2. The system of claim 1, wherein the one or more content access attributes comprise or are based upon one or more of: content type, content tag, authorization level for accessing the content, access credentials, one or more user attributes for accessing the content, authorization level for accessing the particular physical location, or content perceivability.

3. The system of claim 1, wherein the one or more sensors comprise one or more: force sensors, image sensors, scanning devices, wireless communication systems, motion sensors, proximity sensors, depth sensors, thermal imaging sensors, heat sensors, microphones, or biometric sensors.

4. The system of claim 1, wherein the one or more entity authorization attributes comprise one or more of: entity type, entity identity, entity tags, entity state, recorded activity, or field of perception.

5. The system of claim 1, wherein the one or more entity authorization attributes are determined by providing the sensor data as input to one or more artificial intelligence (AI) modules, the one or more AI modules being configured to determine entity authorization attributes based on input sensor data.

6. The system of claim 1, wherein:
the instructions are executable by the one or more processors to further configure the system to assess the one or more entity authorization attributes relative to the one or more content access attributes to determine whether the entity is authorized to access the content presented at the user interface at the particular physical location, and
the interface security action is selected based upon whether the entity is authorized to access the content presented at the user interface at the particular physical location.

7. The system of claim 1, wherein the interface security action comprises a notification presented at the user interface at the particular physical location.

8. The system of claim 1, wherein the interface security action comprises a modification to the presentation of the content at the user interface at the particular physical location.

9. The system of claim 1, wherein the interface security action comprises presentation of a recommended action at the user interface at the particular physical location.

10. The system of claim 1, wherein the instructions are executable by the one or more processors to further configure the system to cause implementation of an additional security action at a separate user interface.

11. A system for facilitating a response to a detected event, comprising:
one or more processors; and
one or more hardware storage devices storing instructions that are executable by the one or more processors to configure the system to:
obtain one or more entity authorization attributes for an entity detected by one or more sensors configured to obtain sensor data associated with entities positioned at one or more physical locations, the one or more physical locations comprising content, the one or more entity authorization attributes indicating authorization of the entity to perform actions associated with the content;
obtain one or more entity activity attributes for the entity detected by at least some of the one or more sensors configured to obtain sensor data associated with the entities positioned at the one or more physical locations; and
generate one or more recommended modifications to the one or more entity authorization attributes for the entity relative to the actions associated with the content based at least upon the one or more entity authorization attributes and the one or more entity activity attributes, wherein generating the one or more recommended modifications to the one or more entity authorization attributes comprises providing at least a portion of the one or more entity activity attributes as input to an artificial intelligence (AI) module, the AI module being configured to generate recommended modifications to authorization attributes for entities based at least upon input entity activity attributes.

12. The system of claim 11, wherein the one or more sensors comprise one or more: force sensors, image sensors, scanning devices, wireless communication systems, motion sensors, proximity sensors, depth sensors, thermal imaging sensors, heat sensors, microphones, or biometric sensors.

13. The system of claim 11, wherein the one or more entity authorization attributes comprise one or more of: entity type, entity identity, entity tags, entity state, recorded activity, or field of perception.

14. The system of claim 11, wherein the one or more recommended modifications to the one or more entity authorization attributes are generated further based upon one or more of: content access attributes associated with the content, content actions associated with the content, or a demand associated with the content actions.

15. A system for facilitating a response to a detected activity, comprising:
one or more processors; and
one or more hardware storage devices storing instructions that are executable by the one or more processors to configure the system to:
obtain one or more entity authorization attributes for one or more entities detected by one or more sensors configured to obtain sensor data associated with entities positioned at a particular physical location, the particular physical location comprising content;
subsequent to collecting the one or more entity authorization attributes for the one or more entities, receive one or more event attributes of an event associated with the content; and
based upon the one or more event attributes and the one or more entity authorization attributes, identify one or more suspect entities from the one or more entities detected by the one or more sensors at the particular physical location.

16. The system of claim 15, wherein the one or more sensors comprise one or more: force sensors, image sensors, scanning devices, wireless communication systems, motion sensors, proximity sensors, depth sensors, thermal imaging sensors, heat sensors, microphones, or biometric sensors.

17. The system of claim 15, wherein the one or more entity authorization attributes comprise one or more of: entity type, entity identity, entity tags, entity state, recorded activity, or field of perception.

18. The system of claim 15, wherein the one or more entity authorization attributes are determined by providing the sensor data as input to one or more artificial intelligence (AI) modules, the one or more AI modules being configured to determine entity authorization attributes based on input sensor data.

19. The system of claim 15, wherein the one or more event attributes comprise one or more indications of: content failure, content corruption, content modification, or content misuse.

20. The system of claim 15, wherein:
the instructions are executable by the one or more processors to further configure the system to assess the one or more entity authorization attributes relative to the one or more event attributes to determine whether the one or more entities were authorized to access the content of the particular physical location, and
at least some of the one or more suspect entities are identified based upon whether the one or more entities were authorized to access the content of the particular physical location.
